(19) United States
(12) Patent Application Publication
(10) Pub. No.: US 2022/0210538 A1
(43) Pub. Date: Jun. 30, 2022

(54) METHOD AND APPARATUS FOR RECOGNIZING WIND NOISE OF EARPHONE

(71) Applicant: Beijing Xiaoniao Tingting Technology Co., LTD., Beijing (CN)

(72) Inventors: Jiudong WANG, Beijing (CN); Song LIU, Beijing (CN)

(73) Assignee: Beijing Xiaoniao Tingting Technology Co., LTD., Beijing (CN)

(21) Appl. No.: 17/645,963

(22) Filed: Dec. 24, 2021

(30) Foreign Application Priority Data
Dec. 25, 2020 (CN) 202011559850.7

(51) Int. Cl. H04R 1/10; H04R 3/00; G10L 21/0208

(52) U.S. Cl. CPC H04R 1/1083; H04R 2410/07; G10L 21/0208; H04R 3/005

(57) ABSTRACT

An earphone includes a first microphone located outside an ear and a second microphone located inside the ear. A method for recognizing wind noise of the earphone includes: a first microphone signal collected by the first microphone and a second microphone signal collected by the second microphone are acquired; a first frequency domain filtered signal is obtained based on the first microphone signal and the second microphone signal; and obtaining a wind noise recognition result of the earphone based on coherence between the first microphone signal and the first frequency domain filtered signal.

### CROSS-REFERENCE TO RELATED APPLICATION

The application claims priority to Chinese Patent Application No. 202011559850.7 filed on Dec. 25, 2020, the disclosure of which is hereby incorporated herein by reference in its entirety.

### BACKGROUND

In a noisy scenario, people often wear active noise cancellation earphones to reduce the noise actually heard by human ears, so as to achieve a better hearing experience. A typical active noise cancellation earphone includes a feedforward noise cancellation microphone outside an ear and a feedback noise cancellation microphone inside the ear. The feedforward noise cancellation microphone outside the ear is configured to detect the noise outside the ear, generate an electrical signal through feedforward noise cancellation, and transmit the electric signal to a loudspeaker to generate an acoustic signal with the same amplitude and opposite direction as the noise inside the ear, so as to achieve a purpose of reducing the noise inside the ear. Since the feedforward noise cancellation has a limited effect, residual noise inside the ear can also be further reduced by the feedback noise cancellation microphone inside the ear through feedback noise cancellation, so as to achieve a better noise cancellation experience. In addition, the existing feedforward noise cancellation microphone and feedback noise cancellation microphone of the active noise cancellation earphone may also be configured to make a call, that is, in an occasion where a user performs a voice call, an noise influence in an uplink voice signal (that is, a voice signal sent to the calling party) is suppressed by a processing algorithm.

### SUMMARY

The disclosure relates to the technical field of wind noise recognition of an earphone, and in particular, to a method and apparatus for recognizing wind noise of an earphone.

In view of this, a main objective of the disclosure is to provide a method and apparatus for recognizing wind noise of an earphone, which are used for solving the technical problem of poor recognition accuracy or high recognition cost of the wind noise recognition method in some implementations.

According to a first aspect of the disclosure, a method for recognizing wind noise of an earphone is provided. The earphone may include a first microphone located outside an ear and a second microphone located inside the ear. The method may include the following operations.

A first microphone signal collected by the first microphone and a second microphone signal collected by the second microphone are acquired.

A first frequency domain filtered signal is acquired based on the first microphone signal and the second microphone signal.

A wind noise recognition result of the earphone is obtained based on coherence between the first microphone signal and the first frequency domain filtered signal.

According to a second aspect of the disclosure, an apparatus for recognizing wind noise of an earphone is provided. The earphone may include a first microphone located outside an ear and a second microphone located inside the ear. The apparatus may include a processor and a memory configured to store instructions executable by the processor, where the processor is configured to:

acquire a first microphone signal collected by the first microphone and a second microphone signal collected by the second microphone;

acquire a first frequency domain filtered signal based on the first microphone signal and the second microphone signal; and

obtain a wind noise recognition result of the earphone based on coherence between the first microphone signal and the first frequency domain filtered signal.

According to a third aspect of the disclosure, an earphone is provided. The earphone may include a first microphone located outside an ear, a second microphone located inside the ear, a loudspeaker, a processor, and a memory storing computer executable instructions.

The executable instructions, when executed by the processor, may cause the processor to implement a method for recognizing wind noise of an earphone. The method includes: acquiring a first microphone signal collected by the first microphone and a second microphone signal collected by the second microphone; acquiring a first frequency domain filtered signal based on the first microphone signal and the second microphone signal; and obtaining a wind noise recognition result of the earphone based on coherence between the first microphone signal and the first frequency domain filtered signal.

According to a fourth aspect of the disclosure, a non-transitory computer-readable storage medium is provided. The computer-readable storage medium may store one or more computer programs. The one or more programs, when being executed by a processor, may implement the abovementioned method for recognizing wind noise of an earphone.

The disclosure has the beneficial effects that: the earphone applied to the method for recognizing wind noise of an earphone according to the embodiment of the disclosure includes the structures, such as the first microphone located outside the ear and the second microphone located inside the ear. When wind noise recognition is performed, first, the first microphone signal collected by the first microphone and the second microphone signal collected by the second microphone are acquired; then, the first frequency domain filtered signal is acquired based on the first microphone signal and the second microphone signal; and finally, a wind noise recognition result of the earphone is obtained based on coherence between the first microphone signal and the first frequency domain filtered signal. According to the method for recognizing wind noise of an earphone of the embodiment of the disclosure, the wind noise recognition is performed by using the existing first microphone located outside the ear and the existing second microphone located inside the ear, other microphones are not needed to be set additionally, the hardware cost is reduced, and the effect of the wind noise recognition is good.

### BRIEF DESCRIPTION OF THE DRAWINGS

Other advantages and benefits will become clear to those of ordinary skill in the art by reading detailed description of the optional embodiments hereinbelow. The accompanying drawings are merely intended to illustrate the objectives of the optional embodiments and are not intended to limit the disclosure. Throughout the accompanying drawings, the same reference numerals represent the same components. In the drawings:

FIG. 1 is a flowchart of a method for recognizing wind noise of an earphone according to an embodiment of the disclosure.

FIG. 2 is a structural schematic diagram of an earphone according to an embodiment of the disclosure.

FIG. 3 is a flow diagram of the method for recognizing wind noise of an earphone according to an embodiment of the disclosure.

FIG. 4 is a block diagram of an apparatus for recognizing wind noise of an earphone according to an embodiment of the disclosure.

FIG. 5 is a structural schematic diagram of the earphone in another embodiment of the disclosure.

### DETAILED DESCRIPTION

The following describes exemplary embodiments of the disclosure in more detail with reference to the accompanying drawings. These embodiments are provided to enable a more thorough understanding of the disclosure and completely convey the scope of the disclosure to a person skilled in the art. Although the exemplary embodiments of the disclosure are shown in the accompanying drawings, it is to be understood that the disclosure may be implemented in various forms and should not be limited by the embodiments set forth herein.

In some usage scenarios, although an earphone has dual microphones including a microphone inside an ear and a microphone outside the ear, such earphone may not work in an active noise cancellation mode (neither microphone is used as a noise cancellation microphone), or only one of the microphones works as a noise cancellation microphone.

The earphone will inevitably encounter wind noise during use. A principle of wind noise generation is: when wind encounters an obstacle, a turbulent flow (also called a disturbed flow) is generated, and the turbulent flow causes a fluctuation in the air pressure near a cavity of the microphone. The noise generated by the turbulent flow is amplified by resonating with an air column in the cavity of the microphone, and the amplified noise is picked up by the microphone, so that wind noise is generated. The wind noise is not generated in a human ear, but only at a microphone end. Therefore, after the feedforward noise cancellation is enabled, the wind noise will cross into the human ear, resulting in a bad experience when a user listens to music. Furthermore, the wind noise will also have an influence on a call, resulting in the decline of call definition. In order to reduce the influence of the wind noise, first, the wind noise needs to be recognized, and then the influence of the wind noise is reduced through some measures.

However, the inventors of the present disclosure have recognized that the wind noise recognition method in some implementations needs to be further improved in terms of recognition accuracy or recognition cost. In addition, in some implementations, there is no solution for wind noise recognition by using an earphone with the dual microphones including an internal microphone and an external microphone.

In some implementations, there is a solution for performing wind noise recognition by using a single microphone outside an ear, which needs to establish a wind noise signal database with different wind power and different wind directions in an early stage, so as to extract wind noise features and perform comparison and recognition. The solution not only has high complexity, but also has a large amount of calculation workload. Once there is wind noise not existing in the database, the recognition accuracy will be greatly reduced.

There is also another solution where wind noise is recognized by using dual microphones outside the ear, which recognizes the wind noise by using the information, such as the correlation of the signals acquired by the dual microphones outside the ear (the correlation of the noise signals generated by the wind noise at the two microphones outside the ear is very low, while the correlation of other external sounds is high), although the accuracy is high, but it is necessary to add another microphone outside the ear in addition to an active noise cancellation earphone. Thus, both the hardware cost and processing overheads will increase.

In addition, in a case where feedforward noise cancellation is enabled or hybrid noise cancellation of the earphone is enabled (that is, the feedforward noise cancellation and the feedback noise cancellation are enabled at the same time), the wind noise outside the ear will cross into the ear after being subjected to feedforward noise cancellation, which results in high coherence between microphone signals inside and outside the ear. In this case, the existence of the wind noise cannot be recognized by using coherence information.

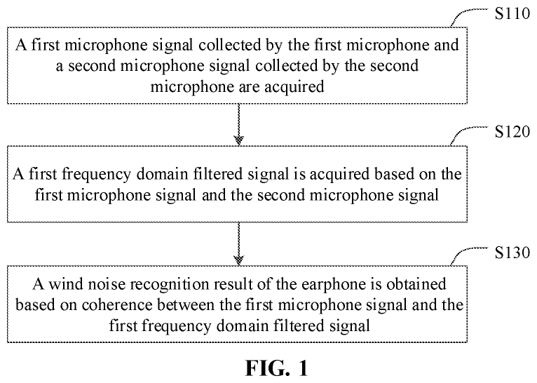

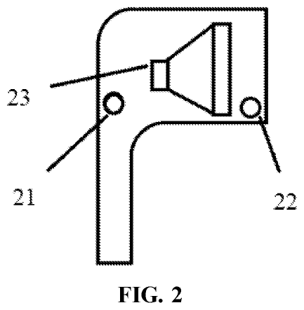

Based on this, some embodiments of the present disclosure are expected to perform wind noise recognition by only using the dual microphones including an internal microphone and an external microphone, rather than using a solution of dual microphones outside the ear. The present disclosure provides a new method to solve the problem about using internal and external microphones to recognize wind when feedforward noise cancellation or hybrid noise cancellation is enabled. Furthermore, for an occasion with non-active noise cancellation, dual microphones inside and outside the ear can also be configured to recognize wind noise and reduce the impact of wind noise. Specifically, FIG. 1 shows a flow diagram of a method for recognizing wind noise of an earphone according to an embodiment of the disclosure. FIG. 2 shows a structural schematic diagram of an earphone provided according to an embodiment of the disclosure. The earphone includes a first microphone 21 outside an ear, arranged at the position, close to the outside of the ear, of an earphone housing, and configured to pick up an ambient noise signal outside the ear; a second microphone 22 inside the ear, arranged at a front end of a loudspeaker, and configured to pick up a noise signal inside the ear, and the loudspeaker 23, configured to play a sound source.

As shown in FIG. 1, the method for recognizing wind noise of an earphone according to the embodiment of the disclosure specifically includes S110 to S130 as follows.

At S110, a first microphone signal collected by the first microphone and a second microphone signal collected by the second microphone are acquired.

The first microphone according to the embodiment of the disclosure is arranged outside of the ear, and may be configured to pick up a first microphone signal outside the ear. The first microphone here may be a feedforward noise cancellation microphone with a feedforward noise cancellation function, and of course, may also be a common microphone without the feedforward noise cancellation function. The second microphone according to the embodiment of the disclosure is arranged inside of the ear, and may be configured to pick up a second microphone signal inside the ear. The second microphone here may be a feedback noise cancellation microphone with a feedback noise cancellation function, and of course, may also be a common microphone without the feedback noise cancellation function.

At S120, a first frequency domain filtered signal is acquired based on the first microphone signal and the second microphone signal.

In order to facilitate subsequent signal calculation and processing, the first microphone signal collected by the first microphone and the second microphone signal collected by the second microphone herein may both be understood as frequency domain signals obtained after Fourier transform processing, and then corresponding filtering processing may be performed on the first microphone signal and the second microphone signal according to different usage scenarios of the earphone, so as to obtain the first frequency domain filtered signal as a basic signal for subsequent wind noise recognition.

At S130, a wind noise recognition result of the earphone is obtained based on coherence between the first microphone signal and the first frequency domain filtered signal.

After the first frequency domain filtered signal is obtained, the coherence between the first frequency domain filtered signal and the first microphone signal may be calculated according to the two, and the wind noise recognition result, including presence of the wind noise and absence of the wind noise, may be determined according to the coherence.

According to the method for recognizing wind noise of an earphone of the embodiment of the disclosure, the wind noise recognition is performed by using the existing first microphone located outside the ear and the existing second microphone located inside the ear, other microphones are not needed to be set additionally, the hardware cost is reduced, and the effect of the wind noise recognition is good.

In an embodiment of the disclosure, when the earphone is not an active noise cancellation earphone, then the second microphone signal is determined as the first frequency domain filtered signal.

When the earphone according to the embodiment of the disclosure is not an active noise cancellation earphone, then the wind noise outside the ear does not cross into the ear, that is, the second microphone signal in the ear will not be affected, so at this time, the second microphone signal may be directly determined as the first frequency domain filtered signal.

In the existence of wind noise, since the microphone outside the ear mainly has a wind noise signal caused by turbulence, which will not affect the inside of the ear basically, and the first microphone signal outside the ear is not relatively correlated with the second microphone signal inside the ear. In the absence of wind noise, an ambient sound outside the ear can partially penetrate into the ear, so as to increases the correlation between the first microphone signal and the second microphone signal. Therefore, wind noise determination may be performed conveniently by calculating a value of coherence between the first microphone signal and the second microphone signal.

In another embodiment of the disclosure, the earphone is an active noise cancellation earphone, the first microphone is a feedforward noise cancellation microphone, and the second microphone does not participate in active noise cancellation, the following processing is performed on the first microphone signal and the second microphone signal to obtain the first frequency domain filtered signal:

FBᵢₙᵥ=FBmic−FFmic×H_{ff}×G. (1)

Herein, FBᵢₙᵥ is the first frequency domain filtered signal, FBmic is the second microphone signal, H_{fb} is a frequency response of a feedback filter used when feedback noise cancellation of the earphone is enabled at a current time, and G is a transfer function from a loudspeaker inside the earphone to the second microphone.

The above formula (1) may be understood as restoring the signal picked up by the second microphone to a state when feedforward noise cancellation of the earphone is not enabled, so as to obtain the first frequency domain filtered signal when only the feedforward noise cancellation of the earphone is enabled. Since the frequency domain signal of the feedforward noise cancellation microphone is produced outside the ear and is not affected by active noise cancellation, it is only necessary to take into account the influence of the frequency domain signal of the feedforward microphone on the frequency domain signal of the second microphone inside the ear.

It can be seen that the signal picked up by the second microphone inside the ear is restored to the state when the feedforward noise cancellation of the earphone is not enabled by the solution through frequency domain filtering processing. When there is wind noise inside the ear at this time, the restored signal of the first microphone signal outside the ear is not relatively correlated with the second microphone signal inside the ear. When there is no wind noise outside the ear at this time, the restored signal of the first microphone signal outside the ear is relatively correlated with the second microphone signal inside the ear. Therefore, wind noise determination may be performed conveniently by calculating a value of coherence between the first microphone signal and the second microphone signal.

In another embodiment of the disclosure, the earphone is an active noise cancellation earphone, the second microphone is a feedback noise cancellation microphone and the first microphone does not participate in active noise cancellation, the following processing may be executed to obtain the first frequency domain filtered signal:

FBᵢₙᵥ=FBmic×(1−H_{fb}×G). (2)

Herein, FBᵢₙᵥ is the first frequency domain filtered signal, FBmic is the second microphone signal, H_{fb} is a frequency response of a feedback filter used when feedback noise cancellation of the earphone is enabled at a current time, and G is a transfer function from a loudspeaker inside the earphone to the second microphone.

Herein, the first frequency domain filtered signal FBᵢₙᵥ obtained by multiplying the second microphone signal FBmic by a gain (1−H_{fb}×G) is the simulated frequency domain signal collected by the second microphone when feedback noise cancellation processing is not performed.

It can be seen that the signal picked up by the second microphone inside the ear is restored to the state when the feedback noise cancellation of the earphone is not enabled by the solution through frequency domain filtering processing. When there is wind noise inside the ear at this time, the restored signal of the first microphone signal outside the ear is not relatively correlated with the second microphone signal inside the ear. When there is no wind noise outside the ear at this time, the restored signal of the first microphone signal outside the ear is relatively correlated with the second microphone signal inside the ear. Therefore, wind noise determination may be performed conveniently by calculating a value of coherence between the first microphone signal and the second microphone signal.

According to a variant of the disclosure, the earphone is an active noise cancellation earphone, the second microphone is a feedback noise cancellation microphone and the first microphone does not participate in active noise cancellation, above filtering processing may not be performed, but the second microphone signal is directly determined as the first frequency domain filtered signal. At this time, since the first microphone does not participate in active noise cancellation, the wind noise outside the ear cannot cross into the ear, that is, the second microphone signal in the ear will not be affected, so at this time, the second microphone signal may be directly determined as the first frequency domain filtered signal. This is not substantially different from the determination result of the first frequency domain filtered signal calculated according to formula (2) above. No matter is the second microphone signal FBmic is multiplied by or not multiplied by a gain, the result of the subsequent calculation of the value of coherence with the first microphone signal will not be affected.

In another embodiment of the disclosure, the earphone is an active noise cancellation earphone, the first microphone is a feedforward noise cancellation microphone and the second microphone is a feedback noise cancellation microphone, the following processing is performed on the first microphone signal and the second microphone signal to obtain the first frequency domain filtered signal:

FB_{invfb}=FBmic×(1−H_{fb}×G), (3)

FBᵢₙᵥ=FB_{invfb}−FFmic×H_{ff}×G. (4)

Herein, FB_{invfb} is an inverse feedback filtering result of the second microphone signal, FBmic is the second microphone signal, H_{fb} is a frequency response of a feedback filter used when feedback noise cancellation of the earphone is enabled at a current time, and G is a transfer function from a loudspeaker in the earphone to the second microphone; and FBᵢₙᵥ is the first frequency domain filtered signal, FFmic is the first microphone signal, and H_{ff} is a frequency response of a feedforward filter used when feedforward noise cancellation of the earphone is enabled at the current time.

The formula (3) above may be regarded as performing inverse feedback filtering processing on the frequency domain signal picked up by the second microphone, i.e., the feedback noise cancellation microphone, in the ear, and the purpose of the inverse feedback filtering processing is to restore the frequency domain signal picked up by the feedback noise cancellation microphone in the ear to a state when the feedback noise cancellation of the earphone is not enabled. The above-mentioned formula (4) may be considered to further restore the signal after the inverse feedback filtering processing to a state when the feedforward noise cancellation of the earphone is not enabled. Therefore, in the embodiments of the disclosure, the inverse feedback filtering processing result before the feedback noise cancellation of the earphone is enabled may be obtained through the formula (3) above, and the inverse hybrid filtering processing result before the hybrid noise cancellation of the earphone is enabled may be obtained through the formula (4) above, and the inverse hybrid filtering processing result is determined as the first frequency domain filtered signal, so that an accurate frequency domain signal may be provided as a basis for subsequent wind noise recognition. A specific calculation process is similar to that mentioned above, and will not elaborated herein.

The transfer function G in the above formulas (1)-(4) may be determined by collecting a sound source signal of the loudspeaker and the second microphone signal picked by the second microphone, and calculating a corresponding relationship therebetween. Here, there may be two calculation methods: one is to obtain the transfer function G by off-line calculation in advance (that is, determine through measurement in a laboratory), and the transfer function G obtained by the off-line calculation in advance may be called directly during use, which consumes shorter time. Considering that different people have different earphone wearing situations, there are also some differences in the structures inside ears, and the coupling degrees between an earphone and the ears of different people are different, the collected signals are also different. Therefore, the transfer function G may be determined by a statistical method after signal data of a plurality of people are collected in advance, so as to improve the calculation accuracy. The other calculation method is to obtain the transfer function G by real-time calculation. The transfer function G may be calculated more accurately according to the coupling degrees between the ears of different people and the earphone, so that the accuracy is relatively higher. Which method is used to calculate the transfer function G specifically may be flexibly selected by those skilled in the art according to actual situations, which is not specifically limited herein.

Specifically, the transfer function obtained by real-time measurement may be calculated based on the following formula (5):

$$G = \frac{E [ FBmic ( f , t ) \times {Ref}^{*} ( f , t ) ]}{E [ \vert Ref ( f , t ) {\vert}^{2} ]} . \qquad ( 5 )$$

Herein, E[ ] is an operation for calculating expectation, a Ref (f, t) signal is a sound source frequency domain signal played by the loudspeaker at time t, FBmic (f, t) is a second microphone signal at time t, and Ref* is a conjugate signal of the Ref signal.

In an embodiment of the disclosure, the operation that the wind noise recognition result of the earphone is obtained based on coherence between the first microphone signal and first frequency domain filtered signal includes: when the coherence is less than a preset threshold value, the wind noise recognition result of the earphone is determined as presence of the wind noise; and when the coherence is not less than the preset threshold value, the wind noise recognition result of the earphone is determined as absence of the wind noise.

After the first microphone signal and the first frequency domain filtered signal are obtained, the coherence between the first microphone signal and the first frequency domain filtered signal may be calculated according to the two, and wind noise determination is performed according to the coherence.

Specifically, when the scenario outside the ear is a common noise scenario (a scenario without wind noise), the coherence is high, while when the scenario outside the ear is a scenario with wind noise, the coherence is low. Based on this, a threshold value T may be set in advance, and it is assumed that

$$C = \vert \frac{E [ FFmic ( f , t ) \times {FB}_{inv}^{*} ( f , t ) ]}{\sqrt{E [ \vert FFmic ( f , t ) {\vert}^{2} ] \times E [ {\vert {FB}_{inv} ( f , t ) \vert}^{2} ]}} \vert ,$$

herein, E[ ] is an operation for calculating expectation, FBmic (f, t) is a first frequency domain signal at time t, FFmic(f,t) is a first microphone signal at time t, and FB*ᵢₙᵥ is a conjugate signal of the FBᵢₙᵥ signal. When C is greater than a preset threshold value T, the wind noise recognition result is determined as absence of the wind noise, and the scenario outside the ear is a scenario without wind noise at this time. When C is less than the preset threshold value T, the wind noise recognition result is determined as presence of the wind noise, and the scenario outside the ear is a scenario with wind noise.

In an embodiment of the disclosure, after the first frequency domain filtered signal is obtained, the method further includes the following steps: a loudspeaker sound source frequency domain signal inside the earphone is acquired; and performing acoustic echo cancellation processing on the first frequency domain filtered signal according to the loudspeaker sound source frequency domain signal.

When the earphone according to the embodiment of the disclosure is in use, the loudspeaker can play a sound source to produce a loudspeaker sound source signal (Ref), for example, a music signal and a downlink signal during calling. The loudspeaker sound source signal crosses into the microphone to cause an acoustic echo after being sent by the loudspeaker, which results in a poor audio effect heard by an opposite user of the call, and furthermore, will affects the accuracy of subsequent wind noise recognition. Therefore, the acoustic echo cancellation processing may be performed herein. According to the embodiments of the disclosure, when the acoustic echo cancellation processing is performed, first the sound source signal played by the loudspeaker is obtained, and then the loudspeaker sound source signal is converted to the frequency domain through Fourier transform, so as to facilitate subsequent calculation.

Since an acoustic echo signal and the loudspeaker sound source signal (Ref) in the signals received by the microphone are related, that is, there is a transfer function (H) from the loudspeaker sound source signal to the acoustic echo signal of the microphone, acoustic echo information of the signal received by the microphone may be estimated through the loudspeaker sound source signal by using relevant information, so as to remove an acoustic echo signal part in the microphone signal.

Specifically, the obtained first frequency domain filtered signal mentioned above serves as a target signal (des), the loudspeaker sound source signal serves as a reference signal (Ref), an optimal filter weight may be obtained by using a Normalized Least Mean Square (NLMS) adaptive algorithm. The filter is an impulse response of the abovementioned transfer function (H). The acoustic echo signal part in a target signal is estimated according to a convolution result of the filter weight and the reference signal, and the target signal after acoustic echo cancellation may be obtained by subtracting the acoustic echo signal part from the target signal. It is to be noted that the abovementioned acoustic echo cancellation processing step is only an optional step. When the loudspeaker of the earphone does not play a sound source, that is, the loudspeaker sound source signal is not produced, at this time, there is no problem about acoustic echo, so an acoustic echo cancellation step may be omitted.

In an embodiment of the disclosure, the method further includes: whether the current environment is quiet is determined based on energy of the first microphone signal and/or the second microphone signal; and when it is determined that the current environment is a quiet environment, even if the coherence is less than the preset threshold value, the environment is not determined as presence of the wind noise.

In a quiet scenario basically without wind noise, the coherence between microphone signals inside and outside the ear is also low. At this time, whether the environment is quiet may be recognized by setting an energy threshold value based on the energy of the first microphone signal and the second microphone signal. When the signal energy picked up by at least one of the first microphone signal and the second microphone signal is lower than the energy threshold value, the scenario may be determined as a quiet scenario, that is to say, although the coherence between microphone signals inside and outside the ear may also be low, the scenario should not be determined as a scenario with wind noise. It is considered that the coherence determination is meaningful only when both the signal energy picked up by the first microphone signal and the signal energy picked up by the second microphone signal are greater than the energy threshold value. The magnitude of the above signal energy may be measured by using a sound pressure level. Of course, those skilled in the art may also measure by other parameters according to actual situations, which is not specifically limited here.

In an embodiment of the disclosure, the method further includes: when it is determined, from the wind noise recognition result of the earphone, that a current environment is an environment with the wind noise, then the wind noise is suppressed in one or more manners as follows: a gain of the first microphone is reduced, the first microphone is turned off, or attenuation is performed on a low-frequency signal of the first microphone signal collected by the first microphone.

After it is recognized that the current scenario is the scenario with the wind noise, a corresponding subsequent processing measure may be taken to reduce adverse effects of the wind noise. For example, the gain of the feedforward noise cancellation microphone is reduced to reduce a situation that the wind noise crosses into the ear due to enabling of the feedforward noise cancellation; or the feedforward noise cancellation microphone is turned off to avoid the situation that the wind noise crosses into the ear due to enabling of the feedforward noise cancellation when there is wind noise; or attenuation is only performed on a low-frequency signal of the feedforward noise cancellation microphone, since the wind noise is mainly concentrated at a low frequency, on one hand, the situation that the wind noise crosses in a low-frequency band inside the ear due to enabling of the feedforward noise cancellation may be reduced, and on the other hand, other frequency bands may also retain a certain noise cancellation effect.

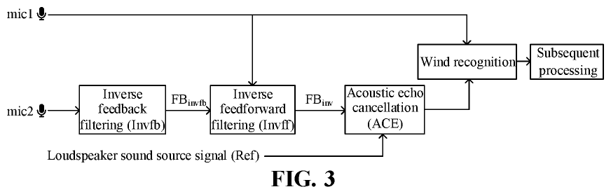

As shown in FIG. 3, taking an embodiment in which dual microphones inside and outside the ear serving as active noise cancellation microphones as an example, a flow chart of wind noise recognition of an earphone is provided. First, the first microphone signal collected by the first microphone mic1 and the second microphone signal collected by the second microphone mic2 are acquire. Then, inverse feedback filtering processing is performed on the second microphone signal to obtain an inverse feedback filtering result FB_{invfb} of the second microphone signal. Inverse feedforward filtering processing is performed on inverse feedback filtering result FB_{invfb} in combination with the first microphone signal, so as to obtain an inverse hybrid filtering result FBᵢₙᵥ, and the inverse mixed filtering result FBᵢₙᵥ is determined as the first frequency domain filtered signal. Next, acoustic echo cancellation processing is performed on the first frequency domain filtered signal according to the loudspeaker sound source signal Ref played by the loudspeaker. Finally, wind noise recognition is performed according to the coherence between the first frequency domain signal after the acoustic echo cancellation processing and the first microphone signal, so as to perform subsequent processing, such as wind noise suppression, according to a wind noise recognition result.

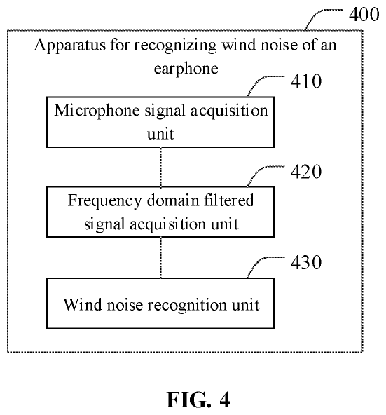

Belonging to the same technical concept as the abovementioned method for recognizing wind noise of an earphone, the embodiments of the disclosure also provide an apparatus for recognizing wind noise of an earphone. An earphone includes a feedforward noise cancellation microphone located outside an ear and a feedback noise cancellation microphone located inside the ear. FIG. 4 shows a block diagram of an apparatus for recognizing wind noise of an earphone according to an embodiment of the disclosure. Referring to FIG. 4, the apparatus for recognizing wind noise of an earphone 400 includes: a microphone signal acquisition unit 410, a frequency domain filtered signal acquisition unit 420, and a wind noise recognition unit 430.

The microphone signal acquisition unit 410 is configured to acquire a first microphone signal collected by the first microphone and a second microphone signal collected by the second microphone.

The frequency domain filtered signal acquisition unit 420 is configured to acquire a first frequency domain filtered signal based on the first microphone signal and the second microphone signal.

The wind noise recognition unit 430 is configured to obtain a wind noise recognition result of the earphone based on coherence between the first microphone signal and the first frequency domain filtered signal.

In an embodiment of the disclosure, the frequency domain filtered signal acquisition unit 420 is specifically configured to: determine the second microphone signal as the first frequency domain filtered signal when the earphone is not an active noise cancellation earphone.

In an embodiment of the disclosure, the frequency domain filtered signal acquisition unit 420 is configured to perform the following operation.

When the earphone is an active noise cancellation earphone, the first microphone is a feedforward noise cancellation microphone, and the second microphone does not participate in active noise cancellation, the following processing is performed on the first microphone signal and the second microphone signal to obtain the first frequency domain filtered signal:

FBᵢₙᵥ=FBmic−FFmic×H_{ff}×G. (1)

Herein, FBᵢₙᵥ is the first frequency domain filtered signal, FBmic is the second microphone signal, the FFmic is the first microphone signal, H_{ff} is a frequency response of a feedforward filter used when feedforward noise cancellation of the earphone is enabled at a current time, and G is a transfer function from a loudspeaker inside the earphone to the second microphone.

In an embodiment of the disclosure, the frequency domain filtered signal acquisition unit 420 is specifically configured to perform the following operation.

When the earphone is an active noise cancellation earphone, the second microphone is a feedback noise cancellation microphone and the first microphone does not participate in active noise cancellation, the second microphone signal is determined as the first frequency domain filtered signal.

Or for the second microphone signal, the following processing is executed to obtain the first frequency domain filtered signal:

FBᵢₙᵥ=FBmic×(1−H_{fb}×G). (2)

Herein, FBᵢₙᵥ is the first frequency domain filtered signal, FBmic is the second microphone signal, H_{fb} is a frequency response of a feedback filter used when feedback noise cancellation of the earphone is enabled at a current time, and G is a transfer function from a loudspeaker inside the earphone to the second microphone.

In an embodiment of the disclosure, the frequency domain filtered signal acquisition unit 420 is specifically configured to:

when the earphone is an active noise cancellation earphone, the first microphone is a feedforward noise cancellation microphone, and the second microphone is a feedback noise cancellation microphone, the following processing is performed on the first microphone signal and the second microphone signal to obtain the first frequency domain filtered signal:

FB_{invfb}=FBmic×(1−H_{fb}×G), (3)

FBᵢₙᵥ=FB_{invfb}−FFmic×H_{ff}×G. (4)

Herein, FB_{invfb} is an inverse feedback filtering result of the second microphone signal, FBmic is the second microphone signal, H_{fb} is a frequency response of a feedback filter used when feedback noise cancellation of the earphone is enabled at a current time, and G is a transfer function from a loudspeaker in the earphone to the second microphone; and FBᵢₙᵥ is the first frequency domain filtered signal, FFmic is the first microphone signal, and H_{ff} is a frequency response of a feedforward filter used when feedforward noise cancellation of the earphone is enabled at the current time.

In an embodiment of the disclosure, the wind noise recognition unit 430 is specifically configured to: determine the wind noise recognition result of the earphone as presence of the wind noise, when the coherence is less than a preset threshold value; and determine the wind noise recognition result of the earphone as absence of the wind noise, when the coherence is not less than the preset threshold value.

In an embodiment of the disclosure, the apparatus further includes: a loudspeaker sound source signal acquisition unit, configured to acquire a loudspeaker sound source frequency domain signal played by the loudspeaker inside the earphone; and an acoustic echo cancellation processing unit, configured to perform acoustic echo cancellation processing on the first frequency domain filtered signal according to the loudspeaker sound source frequency domain signal.

In an embodiment of the disclosure, the apparatus further includes an environment determination unit, configured to: determine whether the current environment is quiet based on energy of the first microphone signal and/or the second microphone signal; and when it is determined that the current environment is a quiet environment, even if the coherence is less than the preset threshold value, not determine the environment as presence of the wind noise.

In an embodiment of the disclosure, the apparatus further includes: a wind noise suppression unit, configured to suppress, when it is determined, from the wind noise recognition result of the earphone, that the current environment is an environment with the wind noise, the wind noise in one or more manners as follows: reducing the gain of the feedforward microphone, turning off the feedforward microphone, or performing attenuation on a low-frequency signal of the first microphone signal collected by the first microphone.

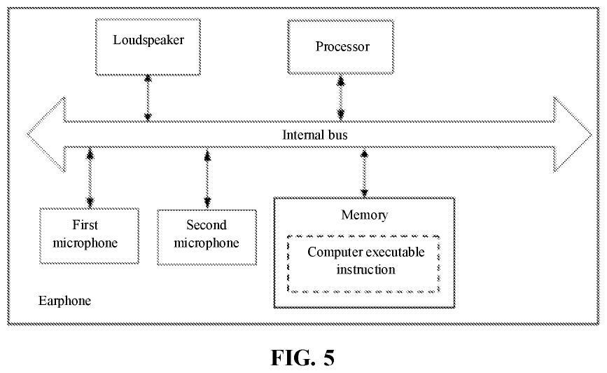

It is to be noted that FIG. 5 shows a structural schematic diagram of an earphone. Referring to FIG. 5, at a hardware level, the earphone includes a first microphone, a second microphone, a loudspeaker, a memory, and a processor. Optionally, the earphone further includes an interface module, a communication module, etc. The memory may include internal memory, such as a Random Access Memory (RAM), and may also include a non-volatile memory, such as at least magnetic disk memory. Of course, the earphone may also include hardware required by other services.

The processor, the interface module, the communication module, and the memory may be interconnected through an internal bus. The internal bus may be an Industry Standard Architecture (ISA) bus, a Peripheral Component Interconnect (PCI) bus, an Extended Industry Standard Architecture (EISA), or the like. The bus may be classified into an address bus, a data bus, a control bus, or the like. For ease of representation, FIG. 5 is only represented by using a bidirectional arrow, but this does not mean that there is only one bus or only one type of bus.

The memory is configured to store a computer executable instruction. The memory provides the computer executable instruction to the processor through an internal bus.

The processor executes the computer executable instruction stored in the memory, and is specifically configured to implement the following operations.

A first microphone signal collected by the first microphone and second microphone signal collected by the second microphone are acquired.

A first frequency domain filtered signal is acquired based on the first microphone signal and second microphone signal.

A wind noise recognition result of the earphone is obtained based on coherence between the first microphone signal and first frequency domain filtered signal.

The functions that are disclosed in the embodiment shown in FIG. 4 of the application and executed by the apparatus for recognizing wind noise of an earphone may be applied to the processor or implemented by the processor. The processor may be an integrated circuit chip with signal processing capability. In the implementation process, each step of the above method may be completed by an integrated logic circuit of hardware in the processor or an instruction in the form of software. The processor may be a general-purpose processor, including a Central Processing Unit (CPU), a Network Processor (NP), etc., or may be a Digital Signal Processor (DSP), an Application Specific Integrated Circuit (ASIC), a Field Programmable Gate Display (FPGA), or other programmable logic devices, discrete gates or transistor logic devices, and discrete hardware components. The methods, steps, and logical block diagrams that are disclosed in the embodiments of this application may be implemented or performed. The general-purpose processor may be a microprocessor, any conventional processor, or the like. Steps of the methods disclosed with reference to the embodiments of this application may be directly performed and accomplished by a hardware decoding processor, or may be performed and accomplished by a combination of hardware and software modules in the decoding processor. The software module may be located in a storage medium mature in the art, such as a random access memory, a flash memory, a read-only memory, a programmable read-only memory or electrically erasable programmable memory, or a register. The storage medium is located in the memory, and the processor reads information in the memory and completes the steps in the foregoing methods in combination with hardware of the processor.

The earphone may further execute the steps of the method for recognizing wind noise of an earphone shown in FIG. 1 and implement the functions of the method for recognizing wind noise of an earphone in the embodiment shown in FIG. 1, which will not be elaborated in the embodiments of the disclosure.

The embodiments of the disclosure further provide a computer-readable storage medium. The computer-readable storage medium stores one or more programs. The one or more programs, when being executed by a processor, implement the foregoing method for recognizing wind noise of an earphone, and are specifically used to execute the following operations.

A first microphone signal collected by the first microphone and second microphone signal collected by the second microphone are acquired.

A first frequency domain filtered signal is acquired based on the first microphone signal and second microphone signal.

A wind noise recognition result of the earphone is obtained based on coherence between the first microphone signal and first frequency domain filtered signal.

A person skilled in the art should understand that the embodiments of the disclosure may be provided as a method, a system, or a computer program product. Thus, the disclosure may adopt forms of complete hardware embodiments, complete software embodiments or embodiments integrating software and hardware. Moreover, the disclosure may adopt the form of a computer program product implemented on one or more computer available storage media (including, but not limited to, a disk memory, a CD-ROM, an optical memory, etc.) containing computer available program code.

The disclosure is described according to flowcharts and/or block diagrams of the method, the device (system), and the computer program product according to the embodiments of the disclosure. It is be understood that each flow and/or block in the flowcharts and/or block diagrams and combinations of flows and/or blocks in the flowcharts and/or block diagrams may be implemented by computer program instructions. These computer program instructions may be provided to a general-purpose computer, a special-purpose computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operating steps are performed on the computer or the another programmable data processing device to produce a computer-implemented process. Therefore, instructions executed on the computer or the another programmable data processing device provide steps for implementing functions specified in one or more flows in the flowcharts and/or one or more blocks in the block diagrams.

In a typical configuration, the computer includes one or more central processing units (CPUs), an input/output interface, a network interface, and a memory.

The memory may include a non-persistent memory, a Random Access Memory (RAM), and/or a non-volatile memory in a computer readable medium, such as a Read-Only Memory (ROM) or a flash RAM. The memory is an example of the computer-readable medium.

The computer-readable medium includes persistent, non-persistent, movable, and unmovable media that may store information by using any method or technology. The information may be a computer-readable instruction, a data structure, a program module, or other data. Examples of computer storage media include, but are not limited to, a phase-change memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disc read-only memory (CD-ROM), a digital versatile disc (DVD) or other optical storage, a magnetic cassette, a magnetic tape, a magnetic disk storage or other magnetic storage devices, or any other non-transmission media, which can be used to store information that can be accessed by a computing device. As definition in the specification, the computer-readable medium does not include computer-readable transitory media such as a modulated data signal and a carrier.

It is also worthwhile to note that the terms “include”, “contain” or any other variations thereof are intended to cover a non-exclusive inclusion, so that a process, method, item, or device including a series of elements includes not only those elements but also other elements not explicitly listed, or elements that are inherent to such process, method, article, or device. In the absence of more restrictions, elements described by the phrase “include a/an . . . ” do not exclude the existence of additional identical elements in the process, method, article, or device that includes the elements.

Those skilled in the art should understand that the embodiments of the disclosure can be provided as methods systems or computer program products. Therefore, the embodiments of the disclosure can adopt forms of complete hardware embodiments, complete software embodiments or embodiments integrating software and hardware. Moreover, the disclosure can adopt the form of a computer program product implemented on one or more computer available storage media (including, but not limited to, a disk memory, a CD-ROM, an optical memory, etc.) containing computer available program code.

The above is only the embodiments of the disclosure, not intended to limit the disclosure. Various changes and variations of the disclosure will occur to those skilled in the art. Any modifications, equivalent substitutions, improvements, etc. that come within the spirit and principles of the disclosure are intended to be included within the scope of the claims of the disclosure.

What is claimed is:

1. A method for recognizing wind noise of an earphone, the earphone comprising a first microphone located outside an ear and a second microphone located inside the ear, wherein the method comprises:
acquiring a first microphone signal collected by the first microphone and a second microphone signal collected by the second microphone;
acquiring a first frequency domain filtered signal based on the first microphone signal and the second microphone signal; and
obtaining a wind noise recognition result of the earphone based on coherence between the first microphone signal and the first frequency domain filtered signal.

2. The method of claim 1, wherein the earphone is an active noise cancellation earphone, the first microphone is a feedforward noise cancellation microphone and the second microphone does not participate in active noise cancellation, the following processing is performed on the first microphone signal and the second microphone signal to obtain the first frequency domain filtered signal:
FBᵢₙᵥ=FBmic−FFmic×H_{ff}×G,
wherein FBᵢₙᵥ is the first frequency domain filtered signal, FBmic is the second microphone signal, the FFmic is the first microphone signal, H_{ff} is a frequency response of a feedforward filter used when feedforward noise cancellation of the earphone is enabled at a current time, and G is a transfer function from a loudspeaker inside the earphone to the second microphone.

3. The method of claim 1, wherein the earphone is an active noise cancellation earphone, the second microphone is a feedback noise cancellation microphone and the first microphone does not participate in active noise cancellation, the second microphone signal is determined as the first frequency domain filtered signal; or
the following processing is performed on the second microphone signal to obtain the first frequency domain filtered signal:
FBᵢₙᵥ=FBmic×(1−H_{fb}×G),
wherein FBᵢₙᵥ is the first frequency domain filtered signal, FBmic is the second microphone signal, H_{fb} is a frequency response of a feedback filter used when feedback noise cancellation of the earphone is enabled at a current time, and G is a transfer function from a loudspeaker inside the earphone to the second microphone.

4. The method of claim 1, wherein the earphone is an active noise cancellation earphone, the first microphone is a feedforward noise cancellation microphone and the second microphone is a feedback noise cancellation microphone, the following processing is performed on the first microphone signal and the second microphone signal to obtain the first frequency domain filtered signal:
FB_{invfb}=FBmic×(1−H_{fb}×G),
FBᵢₙᵥ=FB_{invfb}−FFmic×H_{ff}×G,
wherein FB_{invfb} is an inverse feedback filtering result of the second microphone signal, FBmic is the second microphone signal, H_{fb} is a frequency response of a feedback filter used when feedback noise cancellation of the earphone is enabled at a current time, and G is a transfer function from a loudspeaker inside the earphone to the second microphone; and FBᵢₙᵥ is the first frequency domain filtered signal, FFmic is the first microphone signal, and the H_{ff} is a frequency response of a feedforward filter used when feedforward noise cancellation of the earphone is enabled at the current time.

5. The method of claim 1, wherein obtaining the wind noise recognition result of the earphone based on the coherence between the first microphone signal and the first frequency domain filtered signal comprises:
when the coherence is less than a preset threshold value, determining the wind noise recognition result of the earphone as presence of the wind noise; and when the coherence is not less than the preset threshold value, determining the wind noise recognition result of the earphone as absence of the wind noise.

6. The method of claim 5, further comprising: after acquiring the first frequency domain filtered signal,
acquiring a loudspeaker sound source frequency domain signal played by a loudspeaker inside the earphone; and
performing acoustic echo cancellation processing on the first frequency domain filtered signal according to the loudspeaker sound source frequency domain signal.

7. The method of claim 5, further comprising:
determining whether a current environment is quiet based on energy of the first microphone signal and/or the second microphone signal; and when it is determined that the current environment is a quiet environment, even if the coherence is less than the preset threshold value, not determining the current environment as presence of the wind noise.

8. The method of claim 1, further comprising:
when it is determined, from the wind noise recognition result of the earphone, that a current environment is an environment with the wind noise, suppressing the wind noise in one or more manners as follows: reducing a gain of the first microphone, turning off the first microphone, or performing attenuation on a low-frequency signal of the first microphone signal collected by the first microphone.

9. An apparatus for recognizing wind noise of an earphone, the earphone comprising a first microphone located outside an ear and a second microphone located inside the ear, wherein the apparatus comprises:
a processor; and
a memory configured to store instructions executable by the processor,
wherein the processor is configured to:
acquire a first microphone signal collected by the first microphone and a second microphone signal collected by the second microphone;
acquire a first frequency domain filtered signal based on the first microphone signal and the second microphone signal; and
obtain a wind noise recognition result of the earphone based on coherence between the first microphone signal and the first frequency domain filtered signal.

10. The apparatus of claim 9, wherein the earphone is an active noise cancellation earphone, the first microphone is a feedforward noise cancellation microphone and the second microphone does not participate in active noise cancellation, the following processing is performed on the first microphone signal and the second microphone signal to obtain the first frequency domain filtered signal:
FBᵢₙᵥ=FBmic−FFmic×H_{ff}×G
wherein FBᵢₙᵥ is the first frequency domain filtered signal, FBmic is the second microphone signal, the FFmic is the first microphone signal, H_{ff} is a frequency response of a feedforward filter used when feedforward noise cancellation of the earphone is enabled at a current time, and G is a transfer function from a loudspeaker inside the earphone to the second microphone.

11. The apparatus of claim 9, wherein the earphone is an active noise cancellation earphone, the second microphone is a feedback noise cancellation microphone and the first microphone does not participate in active noise cancellation, the second microphone signal is determined as the first frequency domain filtered signal; or
the following processing is performed on the second microphone signal to obtain the first frequency domain filtered signal:
FBᵢₙᵥ=FBmic×(1−H_{fb}×G),
wherein FBᵢₙᵥ is the first frequency domain filtered signal, FBmic is the second microphone signal, H_{fb} is a frequency response of a feedback filter used when feedback noise cancellation of the earphone is enabled at a current time, and G is a transfer function from a loudspeaker inside the earphone to the second microphone.

12. The apparatus of claim 9, wherein the earphone is an active noise cancellation earphone, the first microphone is a feedforward noise cancellation microphone and the second microphone is a feedback noise cancellation microphone, the following processing is performed on the first microphone signal and the second microphone signal to obtain the first frequency domain filtered signal:
FB_{invfb}=FBmic×(1−H_{fb}×G),
FBᵢₙᵥ=FB_{invfb}−FFmic×H_{ff}×G,
wherein FB_{invfb} is an inverse feedback filtering result of the second microphone signal, FBmic is the second microphone signal, H_{fb} is a frequency response of a feedback filter used when feedback noise cancellation of the earphone is enabled at a current time, and G is a transfer function from a loudspeaker inside the earphone to the second microphone; and FBᵢₙᵥ is the first frequency domain filtered signal, FFmic is the first microphone signal, and the H_{ff} is a frequency response of a feedforward filter used when feedforward noise cancellation of the earphone is enabled at the current time.

13. The apparatus of claim 9, wherein in order to obtain the wind noise recognition result of the earphone based on the coherence between the first microphone signal and the first frequency domain filtered signal, the processor is configured to:
when the coherence is less than a preset threshold value, determine the wind noise recognition result of the earphone as presence of the wind noise; and when the coherence is not less than the preset threshold value, determine the wind noise recognition result of the earphone as absence of the wind noise.

14. The apparatus of claim 13, wherein the processor is further configured to: after acquiring the first frequency domain filtered signal,
acquire a loudspeaker sound source frequency domain signal played by a loudspeaker inside the earphone; and
perform acoustic echo cancellation processing on the first frequency domain filtered signal according to the loudspeaker sound source frequency domain signal.

15. The apparatus of claim 13, wherein the processor is further configured to:
determine whether a current environment is quiet based on energy of the first microphone signal and/or the second microphone signal; and when it is determined that the current environment is a quiet environment, even if the coherence is less than the preset threshold value, not determine the current environment as presence of the wind noise.

16. The apparatus of claim 9, wherein the processor is further configured to:
when it is determined, from the wind noise recognition result of the earphone, that a current environment is an environment with the wind noise, suppress the wind noise in one or more manners as follows: reducing a gain of the first microphone, turning off the first microphone, or performing attenuation on a low-frequency signal of the first microphone signal collected by the first microphone.

17. An earphone, comprising a first microphone located outside an ear, a second microphone located inside the ear, a loudspeaker, a processor and a memory storing computer executable instructions,
wherein the executable instructions, when executed by the processor, cause the processor to implement a method for recognizing wind noise of an earphone, the method comprising:
acquiring a first microphone signal collected by the first microphone and a second microphone signal collected by the second microphone;
acquiring a first frequency domain filtered signal based on the first microphone signal and the second microphone signal; and
obtaining a wind noise recognition result of the earphone based on coherence between the first microphone signal and the first frequency domain filtered signal.

18. The earphone of claim 17, wherein the earphone is an active noise cancellation earphone, the first microphone is a feedforward noise cancellation microphone and the second microphone does not participate in active noise cancellation, the following processing is performed on the first microphone signal and the second microphone signal to obtain the first frequency domain filtered signal:
FBᵢₙᵥ=FBmic−FFmic×H_{ff}×G,
wherein FBᵢₙᵥ is the first frequency domain filtered signal, FBmic is the second microphone signal, the FFmic is the first microphone signal, H_{ff} is a frequency response of a feedforward filter used when feedforward noise cancellation of the earphone is enabled at a current time, and G is a transfer function from a loudspeaker inside the earphone to the second microphone.

19. The earphone of claim 17, wherein the earphone is an active noise cancellation earphone, the second microphone is a feedback noise cancellation microphone and the first microphone does not participate in active noise cancellation, the second microphone signal is determined as the first frequency domain filtered signal; or
the following processing is performed on the second microphone signal to obtain the first frequency domain filtered signal:
FBᵢₙᵥ=FBmic×(1−H_{fb}×G),
wherein FBᵢₙᵥ is the first frequency domain filtered signal, FBmic is the second microphone signal, H_{fb} is a frequency response of a feedback filter used when feedback noise cancellation of the earphone is enabled at a current time, and G is a transfer function from a loudspeaker inside the earphone to the second microphone.

20. The earphone of claim 17, wherein the earphone is an active noise cancellation earphone, the first microphone is a feedforward noise cancellation microphone and the second microphone is a feedback noise cancellation microphone, the following processing is performed on the first microphone signal and the second microphone signal to obtain the first frequency domain filtered signal:
FB_{invfb}=FBmic×(1−H_{fb}×G),
FBᵢₙᵥ=FB_{invfb}−FFmic×H_{ff}×G,
wherein FB_{invfb} is an inverse feedback filtering result of the second microphone signal, FBmic is the second microphone signal, H_{fb} is a frequency response of a feedback filter used when feedback noise cancellation of the earphone is enabled at a current time, and G is a transfer function from a loudspeaker inside the earphone to the second microphone; and FBᵢₙᵥ is the first frequency domain filtered signal, FFmic is the first microphone signal, and the H_{ff} is a frequency response of a feedforward filter used when feedforward noise cancellation of the earphone is enabled at the current time.
